(19) United States
(12) Patent Application Publication
(10) Pub. No.: US 2021/0293382 A1
(43) Pub. Date: Sep. 23, 2021

(54) DEVICE FOR STORING GAS BY SORPTION

(71) Applicant: AAQIUS & AAQIUS SA, Geneve (CH)

(72) Inventors: Michael Francis LEVY, Paris (FR); Jorn OUBRAHAM, Paris (FR); Carsten POHLMANN, Issy Les Moulineaux (FR); Jean-Baptiste DEMENTHON, Paris (FR)

(73) Assignee: AAQIUS & AAQIUS SA, Geneve (CH)

(21) Appl. No.: 17/264,819

(22) PCT Filed: Jul. 31, 2019
(86) PCT No.: PCT/EP2019/070601

§ 371 Date: Jan. 31, 2021

(30) Foreign Application Priority Data
Jul. 31, 2018 (FR) 1857181

(51) Int. Cl. F17C 11/00; B01J 20/28

(52) U.S. Cl. CPC F17C 11/005; B01J 20/28002; F17C 2270/0184; F17C 2221/012; F17C 2270/0168; B01J 20/28035

(57) ABSTRACT

The invention relates to a sorption-based gas storage structure (10) comprising: —a first layer (100) comprising a sorption-based storage material, —a second layer (200) comprising: º a first portion (201, 203) of the second layer, in contact with the first layer (100), and º a second portion (202) of the second layer.

### FIELD OF THE INVENTION

The invention relates to the storage of gas by sorption.

More specifically, the invention relates to a structure for storing gas by sorption, a device for storing gas by sorption, a system for storing and/or supplying gas, and a related method.

### STATE OF THE ART

The use of gases in industry, whether in the mobility, energy, chemical or production sectors, is subject to multiple constraints. In this respect, many gas storage devices have already been proposed. Some of these devices may comprise a solid material to store a gas.

Such solid storage devices must present specific properties in order to meet the constraints induced by the gas and related to the conditions of its use. Gas stored in solid form can, for example, when used as an energy carrier, power a fuel cell. In the mobility sector, it can also be used within a motor vehicle.

Depending on the intended use, storage structures are dimensioned in different ways due to the choice of storage material and its size. For example, it is known to provide storage material in compressed powder form in stacked boxes.

In any case, the management of the storage material is an essential issue to guarantee the performance of such devices. In this respect, it is for example known to arrange the storage material inside an enclosure.

However, known systems are exposed to problems of efficiency and homogenisation of the behaviour of the storage material, robustness and longevity of the storage structures, safety of use, complexity of manufacture, and economic and energy efficiency in the implementation of the said systems.

As an example, the US document 2005/0188847 describes an enclosure into which a heat exchanger extends. The heat exchanger consists of pipes to which fins are transversely attached, delimiting interstices between them, some of which are filled with an alloy for the storage of hydrogen in solid form. The remaining empty interstices are configured to be irreversibly crushed due to the expansion of the alloy.

### DESCRIPTION OF THE INVENTION

One objective of the invention is to alleviate at least one of the disadvantages listed above.

Another objective of the invention is to allow an optimized gas storage, for example more efficient or more robust, in a storage material.

Another objective of the invention is to facilitate the handling of a gas storage structure, in particular during its manufacture.

Another objective of the invention is to simplify the manufacture, maintenance and/or recycling of a gas storage structure, in particular by reducing the costs related to these operations.

Another objective of the invention is to reduce the mechanical constraints within a gas storage structure.

Another objective of the invention is to facilitate heat exchange within a gas storage structure.

Another object of the invention is to propose a storage structure that can be easily adapted to the needs of gas storage and/or supply performance.

In particular, the invention relates to a gas storage structure by sorption comprising:
a first layer comprising a sorption storage material,
a second layer comprising:
   a first portion of a second layer, in contact with the first layer, and comprising a thermally conductive material, having a higher thermal conductivity than the storage material, for increasing heat transfer within the storage structure, and
   a second part of second layer, comprising a material being:
      compressible in order to deform under the action of forces exerted by the storage material during variations in the volume of the storage material during gas sorption and desorption phases,
      of higher compressibility than the material of the first part, and
      thermally conductive, with higher thermal conductivity than the storage material, to increase heat transfer within the storage structure.

In such a structure, thanks to the second layer, gas sorption and desorption phenomena by the storage material, which involve significant heat flow, are facilitated. In addition, the second layer acts as a buffer during the operation of the storage structure, in order to distribute the mechanical stresses in an optimal way within the said structure. This is particularly advantageous when gas storage by sorption is reversible. Indeed, the alternating sorption and desorption phases lead to cyclic variations in the volume of the storage material, which are compensated by the material of the second part of the second layer. In addition, this compensation can be achieved in several successive cycles, in which the material of the second part of the second layer can expand again after being compressed, unlike the interstices described in US 2005/018847, which are crushed irreversibly.

Advantageously but optionally, the device according to the invention may furthermore comprise at least one of the following features, taken alone or in combination:
The material of the first part presents a lower porosity than the material of the second part.
The storage material is in pre-compressed powder form,
The first part is a first sublayer and/or the second part is a second sublayer,
for at least one second sublayer, the second sublayer is disposed between the first sublayer and a third sublayer of the second layer, in contact with another of the at least one first layer, and comprising a thermally conductive material of higher thermal conductivity than the storage material, to increase thermal transfers within the storage structure,
the structure comprises an alternation of first layers and second layers, preferably the first layers being separated two by two by one of the second layers,
the structure comprises alternating wafers, preferably wafers mechanically independent from each other, preferably each first layer and/or each second layer forming a wafer, and
the sorption storage material is a reversible sorption gas storage material,
the second layer is adapted to compensate by an elastic deformation the “breathing” of the first layer during storage and/or gas supply.

Another object of the invention also relates to a device for storing gas by sorption.
including:
a storage structure as previously described,
an enclosure, with the storage structure being located inside the enclosure.

Another object of the invention also relates to a system of storage and/or supply of gas comprising a storage device as previously described, and a gas utilization unit.

Another object of the invention also relates to a method for storing and/or supplying gas by means of a storage structure as previously described, or a storage device as previously described, or a gas storage and/or supply system as previously described, comprising a step of storing gas by sorption through the first layer.

Advantageously, but optionally, the device according to the invention may in addition comprise at least one of the following features, taken alone or in combination:
the method further comprises the steps of:
   plastic compression of the materials of the second layer, and
   elastic compression and/or decompression of the materials of the second layer.

### DESCRIPTION OF THE FIGURES

Other features, objectives and advantages of the present invention will appear on reading the detailed description that follows and in relation to the appended drawings given as a non-limiting example and wherein:

FIG. 1 shows a gas storage structure according to an example of an embodiment of the invention,

FIG. 2 shows the evolution of a second layer of the storage structure in FIG. 1, during the operation of the said structure,

FIG. 3 illustrates a gas storage device according to an example of an embodiment of the invention,

FIG. 4 shows a gas storage and/or supply system according to an example of an embodiment of the invention, and

FIG. 5 is a flowchart illustrating a method for storing and/or supplying gas according to an example of implementation of the invention.

### DETAILED DESCRIPTION OF THE INVENTION

With reference to the figures, a structure and a device for gas storage by sorption will now be described, as well as a system and method for gas storage and/or gas supply.

The stored gas can be of any nature and type. For example, the storage structure may store hydrogen, ammonia, water vapor, oxygen, and/or carbon dioxide alone, or in combination.

Gas Storage Structure

With reference to FIG. 1, a sorption gas storage structure 10 consists of a first layer 100 and a second layer 200.

The first layer 100 is configured to store gas by sorption. For this purpose, it may comprise a sorption storage material.

The sorption storage material can be a reversible or irreversible sorption gas storage material. Reversible means that a material initially loaded by sorption and which has been at least partially discharged by sorption can at least partially reload the medium in which the material is stored. In the case of irreversible sorption, the gas can only be desorbed once and cannot be resorbed by the material again.

Advantageously, the storage material can be in a pre-compressed powder form. Indeed, this form facilitates the transport of the storage material because it is easier to handle and has a smaller volume. In addition, this form is more suitable for the sorption storage operation, as it is more stable, facilitates heat transfer and makes the expansion of the storage material more homogeneous.

In addition, the material may present an optimized porosity to increase the volumetric storage capacity of the storage structure, but also to accommodate the volume variations of the second layer 200. For example, the porosity of the storage material is comprised between 10 vol. % and 50 vol. %, and preferably between 25 vol. % and 35 vol. %. The porosity is defined as the ratio of the volume not occupied by the storage material within a given volume of the storage material, of the said given volume. In other words, the porosity is the ratio of the volume not occupied by the storage material to its apparent volume, i.e. the porosity is equal to the ratio of the theoretical density from which the apparent density is subtracted to the theoretical density. In any case, the pre-compressed powdered form makes it possible to control the porosity of the storage material.

In addition, the storage material may comprise:
a material suitable for forming a metal hydride, preferably of the MgH₂, NaAlH₄, LiNH₂, and/or LiBH₄ type, and/or
a material suitable for forming an intermediate alloy, preferably of the TiMn₂, TiCr₂, LaNi₅, FeTi, TiV, and/or TiZr type, and/or
a material suitable for forming an ammonia salt, preferably of the BaCl₂ type, and/or CaOl₂, or
a material suitable for forming a hydroxide, preferably of the CaO type, and/or Ca(OH)₂, or
a material suitable for forming an oxide, preferably of the PbO, and/or CaO type.

The applicant has indeed found that the above materials are particularly suitable for storing and/or supplying gas such as hydrogen, ammonia, water vapour, oxygen, and/or carbon dioxide. This is, however, not limiting since such materials can also be particularly suitable for other types of gases.

The second layer 200 may comprise a material being:
thermally conductive, with a higher thermal conductivity than the storage material, in order to increase heat transfer within the storage structure 10, and
compressible in order to deform under the action of forces exerted by the storage material during variations in the volume of the storage material during the gas sorption and desorption phases.

Thanks to the second layer 200, gas sorption and desorption phenomena by the storage material, which involve significant heat flow, are facilitated. In fact, the heat transfers are homogeneously distributed throughout the entire storage structure 10, which reinforces its efficiency and durability. In fact, heat can be easily conveyed and extracted from the first layer 100, which ensures the rapid storage and/or retrieval of gas within storage structure 10. The energy stored by a given mass of storage material is therefore advantageously increased. Advantageously, the dimensions, shape, and relative positioning of the first layer 100 and the second layer 200 make it possible to optimize heat transfers within the storage structure 10. For example, when the first layer 100 and the second layer 200 extend in a preferred longitudinal direction, as shown in FIG. 1, the layer thickness along a section orthogonal to the longitudinal direction is a possible lever for optimizing heat flows within storage structure 10. Alternatively, or in combination, providing a storage material porosity gradient within the first layer 100, in a radial direction with respect to the longitudinal direction, is also a possible route for optimizing heat exchange within storage structure 10. Indeed, it can be observed that, when the first layer 100 and the second layer 200 extend in a longitudinal direction, the radial direction constitutes a preferred direction of heat exchange within the storage structure 10. In any case, most of the heat emitted or received by the first layer 100 is transferred by the second layer 200.

In addition, the second layer 200 acts as a buffer during the operation of the storage structure 10. Indeed, the second layer 200 compensates for the variations in volume of the storage material during the gas sorption and desorption phases, thus preserving the mechanical coherence of the storage structure 10. In this way, the volumetric capacity of the storage material is advantageously increased, since it is no longer necessary to create empty spaces within the storage structure 10, as in the storage system described in the US 2005/0188847 document. Finally, the second layer 200 distributes the mechanical forces resulting from volume variations of the storage material during operation.

Gas can be supplied to and/or extracted from the storage material through any suitable diffuser (not shown). Advantageously the diffuser extends in a longitudinal direction that corresponds to the preferred direction of the storage structure 10, and the gas is distributed from and/or to the storage material in a radial direction to this preferred direction.

Alternating Structure

As shown in FIG. 1, in one embodiment, the storage structure 10 comprises the first layer 100 and the second layer 200, alternating. Preferably, the storage structure 10 comprises alternating first layers 100 and second layers 200, the first layers 100 preferably being separated two by two by one of the second layers 200. The alternating repartition facilitates in particular the distribution of thermal and mechanical stresses within the storage structure 10. In addition, an alternating structure is easily reproducible on an industrial scale, both at the manufacturing and maintenance stages of the storage structure 10. Moreover, such a structure can easily be adapted according to the storage and/or gas supply performance requirements. Finally, such a repartition allows a compactness of the storage structure 10 that can be particularly advantageous for applications such as transportation, for example automotive.

Advantageously, the storage structure 10 comprises an alternation of wafers, each first layer 100 and/or each second layer 200 preferably forming a wafer. Preferably, but optionally, the wafers are mechanically independent of each other. Such a configuration can also facilitate the handling of the different elements of the storage structure during the various operations related to the manufacture, maintenance and/or recycling of the storage structure 10. In addition, the wafer configuration promotes geometric optimization of the repartition and distribution of materials within the storage structure 10. Moreover, this configuration is more suitable for sorption storage operation because it is more stable, facilitates heat transfer, and makes the expansion of the storage material more homogeneous. Thus, the gas can be better distributed throughout the storage structure 10 when loading the storage material.

Second-Layer Parts

Still with reference to FIG. 1, in one embodiment, the second layer 200 can comprise a first part of the second layer 201, 203 in contact with the first layer 100, and a second part of the second layer 202.

In this configuration, the first part 201, 203 can then comprise a thermally conductive material, with a higher thermal conductivity than the storage material, in order to increase heat transfer within the storage structure. The second part 202 may, however, comprise a compressible material to deform under the action of forces exerted by the storage material during variations in the volume of the storage material during the gas sorption and desorption phase. In addition, the material of the second part 202 is advantageously of higher compressibility than the first part material. By compressibility, we understand the capacity of a material to decrease its volume when subjected to a given compressive stress. Thus, for the same compressive stress, the decrease in volume of the material of the second part 202 is greater than the decrease in volume of the first part 201, 203. In other words, in order to achieve a given rate of decrease in volume of the material of the first part 201, 203 and material of the second part 202, greater compressive forces are required for the material of the second part 201, 203 than for the material of the second part 202 material. In any case, the material of the second part 202 is also thermally conductive, with a higher thermal conductivity than the storage material, in order to increase heat transfer within the storage structure 10.

The functions of the second layer 200 are then partially distributed between the first part 201, 203 and the second part 202. In this way, each of these functions can be optimized independently of the other, which improves the overall efficiency of the storage structure 10, and further allows the storage structure 10 to be further adapted according to gas supply and/or storage requirements. In addition, the presence of a thermally conductive material in each of the two parts 201, 202, 203 ensures that heat exchanges within the storage structure 10 are facilitated in order to distribute heat evenly throughout the storage structure 10.

The material in the first part 201, 203 can be identical to the material of the second part 202. This results in an advantageous cost reduction and simplification of the manufacturing of the storage structure 10. Alternatively, the material of the first part 201, 203 can be different from the material of the second part 202. This facilitates the adaptation of the storage structure 10 to optimize its storage and/or supply capacity for a given gas.

Furthermore, the material of the first part 201, 203, and/or the material of the second part 202, may comprise a matrix comprising graphite, for example natural graphite, for example expanded natural graphite. Alternatively, or as a complement, the material of the first part 201, 203 may comprise a metal, for example aluminum or copper. Alternatively, or as a complement, the material of the second part 202 may comprise a foam. The applicant has determined that these materials have adequate compressibility and/or heat transfer properties to perform the functions of the first part 201, 203 and/or the second part 202 of a storage structure 10.

In addition, the material of the first part 201, 203 may in addition, present lower porosity than the material of the second part 202. The porosity is a parameter that influences both the compressibility and the thermal properties of a material. Consequently, this difference in porosity favors the deformation of the second part 202 under the action of forces exerted by the storage material during variations in the volume of the storage material during the gas sorption and desorption phases, and allows the first part 201, 203 to increase the heat transfer within the storage structure 10. Specifically, the material of the first part 201, 203 may present porosity of less than 50%, preferably less than 15%, and in a preferred manner, preferably less than 5%.

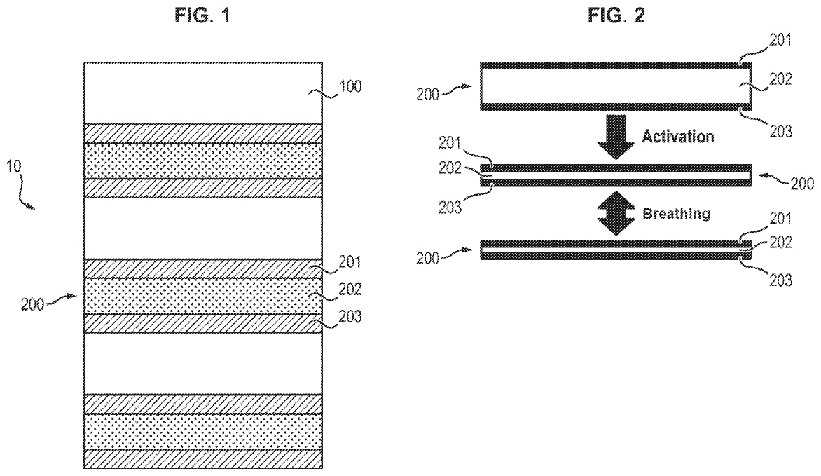

With reference to FIG. 2, the mechanical properties of the second layer 200 evolve during the different operating cycles of storage structure 10.

Indeed, the first operating cycles of the storage structure 10 allow activation of the first layer 100. More precisely, during the first loading and/or unloading cycles of the storage structure 10, the storage material comprised in the first layer 100 will acquire its full storage capacity by sorption. This initial conditioning can be implemented during loading and/or unloading cycles that can be long-lasting and/or carried out at high temperature and/or high pressure. In this respect, it should be noted that when the storage material is in pre-compressed powder form, activation is facilitated because the number and duration of the first loading and/or unloading cycles is reduced. Gradually, the quantity of gas stored and then released by the first layer 100 increases, as successive loading and/or unloading takes place, until an expected storage level is reached under given temperature and pressure conditions. This expected level corresponds to the maximum quantity of gas that can be stored in the first layer 100 at a given temperature and pressure. Once this level is reached, the storage material is activated. However, this or these first operating cycle(s) lead to significant changes in the volume of the first layer. This leads to a plastic compression of the second layer 200, mainly by plastic compression of the second part of the second layer 202, as can be seen in FIG. 2.

Subsequently, the volume variations of the first layer 100, during storage and/or gas release, are less important than during activation of the storage material. This introduces the notion of first layer 100 breathing. These small volume variations are compensated by an elastic deformation of the second layer 200 as shown in FIG. 2. Thus, the first part 201, 203 may have a thickness of less than 5 millimeters, preferably about 2 millimeters, and in a preferred manner, about 1 millimeter. The second part 202 can, for its part, have, before activation of the storage material, a thickness of between 2 and 10 millimetres, preferably between 2 and 8 millimetres, and in a preferred manner, between 2 and 4 millimetres. The applicant has found that these thicknesses guarantee the best thermal conductivity within the storage structure 10, but also a good compensation of the forces exerted by the storage material during variations in the volume of the storage material during gas sorption and desorption phases. In any case, the plastic compression of the second layer 200 leads to a reduction in height of the second layer 200 of the order of 20 to 60% compared to its initial height, before activation, and the elastic compression leads to a reduction in height of the second layer 200 of the order of 80 to 99% compared to its initial height, before activation.

In addition, the material of the second layer 202 may have, before activation of the storage material, a porosity of more than 70%, preferably more than 80%, and in a preferred manner, more than 95% and, after activation of the storage material, a porosity of more than 20%, preferably more than 30%, and in a preferred manner, between 45% and 60%. The applicant has found that these porosities guarantee the best thermal conductivity within the storage structure 10, but also a good compensation of the forces exerted by the storage material during variations in the volume of the storage material during gas sorption and desorption phases.

As can be seen in FIGS. 1 to 3, the first part 201, 203 can be a first sub-layer and/or the second part 202 can be a second sub-layer. This guarantees a structural homogeneity that facilitates manufacturing, maintenance and/or recycling operations of the storage structure 10. In addition, the functions of the second layer 200 can be ensured while maintaining a good compactness of the storage structure 10. However, this is not limiting, since other forms of first part 201, 203 and second part 202 are possible. For example, the second layer 202 can also be structured in angular sectors, each sector corresponding to one or the other of the first part 201, 203 and second part 202.

Advantageously, with reference to FIG. 1, for at least one second layer 200, the second sublayer 202 can be arranged between the first sublayer 201 and a third sublayer of the second layer 203, in contact with another of the at least one first layer 100, and comprising a thermally conductive material with a higher thermal conductivity than that of the storage material, in order to increase heat transfer within the storage structure. In this “sandwich” configuration of the second layer 200, the second sublayer 202 is not in contact with the first layer 100. This configuration allowing for optimization of the heat transfer through the storage structure 10.

Storage Device

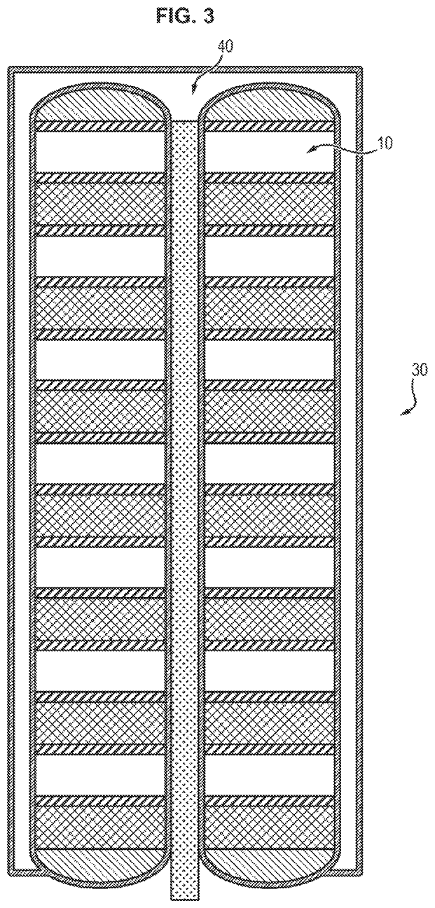

Referring to FIG. 3, a sorption gas storage device 30 comprises a storage structure 10 according to one of the previously described embodiments, and an enclosure 40, with the storage structure 10 being arranged inside the enclosure 40.

The presence of the enclosure 40 facilitates the transport and handling of storage structure 10, but also its integration within global structures, such as a car for example. In addition, the presence of the second layer 200 makes it possible to alleviate the mechanical and thermal stresses that storage structure 10 exerts on enclosure 40 during operation. Thus, such a storage device 30 is more robust.

Gas Storage and/or Supply System

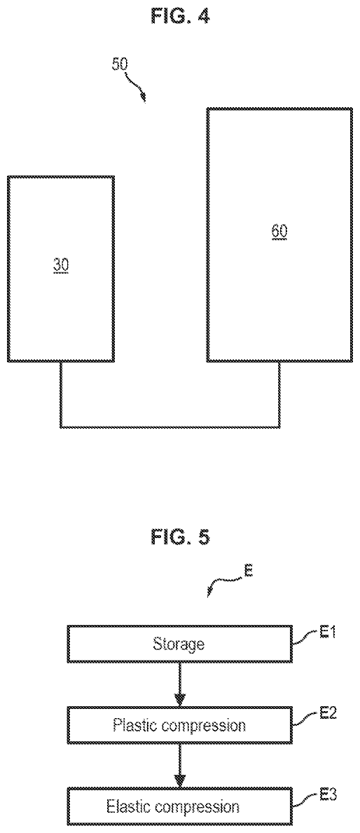

With reference to FIG. 4, a gas storage and/or supply system 50 comprises a sorption gas storage device 30 in any of the above-described embodiments, and a gas utilization unit 60.

The gas utilization unit 60 may, for example, be a motor vehicle fuel cell when the stored gas is hydrogen.

Gas Storage and/or Supply Method

With reference to FIG. 5, a method for storing and/or supplying gas E by means of a sorption gas storage structure 10 and/or a sorption gas storage device 30 and/or a gas storage and/or supply system 50, according to any of the previously described embodiments, comprises a step E1 of storing by sorption gas by the first layer 100.

Advantageously, the method E further comprises the steps of plastic compression E2 of the materials of the second layer 200 and of elastic compression and/or decompression E3 of said materials of the second layer 200. These steps E2, E3 correspond to the previously described processes of activation E2 and then breathing E3.

1. A sorption gas storage structure comprising:
a first layer comprising a sorption storage material,
a second layer comprising:
a first portion of the second layer, in contact with the first layer, and comprising a thermally conductive material, of higher thermal conductivity than that of the storage material, in order to increase heat transfer within the storage structure, and
a second portion of the second layer, comprising a material being:
compressible in order to deform under the action of forces exerted by the storage material during variations in the volume of the storage material during gas sorption and desorption phases,
of higher compressibility than the material of the first portion, and
thermally conductive, with higher thermal conductivity than the storage material, in order to increase heat transfer within the storage structure.

2. The storage structure according to claim 1, wherein the first portion has a lower porosity than the material of the second part.

3. The storage structure according to claim 1, wherein the storage material is in pre-compressed powder form.

4. The storage structure according to claim 1, wherein the first portion is a first underlayer and/or the second portion is a second underlayer.

5. The storage structure according to claim 4, wherein for at least one of the second layer and the second underlayer (200) is arranged between the first underlayer and a third underlayer of the second layer, in contact with another of the at least one first layer, and comprises a thermally conductive material with a higher thermal conductivity than that of the storage material, in order to increase heat transfer within the storage structure.

6. The storage structure according to claim 1, in which the structure comprises alternating first layers and second layers.

7. The storage structure according to claim 1, wherein the structure comprises an alternation of wafers.

8. A sorption gas storage device comprising:
a storage structure according to claim 1, and
an enclosure, the storage structure being disposed within the enclosure.

9. A gas storage and/or supply system comprising a storage device according to claim 8, and a gas utilization unit.

10. A method for storing and/or supplying gas using a storage structure according to claim 1, comprising a step of storing gas by sorption through the first layer.

11. The method for storing and/or supplying gas according to claim 10 further comprising the steps of:
plastic compression of the materials of the second layer and,
elastic compression and/or decompression of the materials of the second layer.

12. The storage structure according to claim 6, wherein the first layers are separated two by two by one of the second layers.

13. The storage structure according to claim 1, wherein the structure comprises an alternation of wafers that are mechanically independent of each other.

14. The storage structure according to claim 1, wherein the structure comprises an alternation of wafers and each first layer and/or each second layer forms a wafer.

15. A method for storing and/or supplying gas by means of a storage device according to claim 8, comprising a step of storing gas by sorption through the first layer.

16. A method for storing and/or supplying gas by means of a system according to claim 9, comprising a step of storing gas by sorption through the first layer.
